(19) United States
(12) Patent Application Publication
(10) Pub. No.: US 2020/0305479 A1
(43) Pub. Date: Oct. 1, 2020

(54) MUSHROOM BASED COMPOSITIONS FOR CONFERRING FLAVOUR TO LIQUIDS

(71) Applicant: The Mushroom Benefit Ltd, Natanya (IL)

(72) Inventors: Marilyn WEIGENSBERG, Tekoa (IL); Aharon Bar-Tur, Tel Aviv (IL); Oren Kessler, Tekoa (IL); Harold Kruger, Hadar Am (IL); Arturo Geifman, Hod Hasharon (IL); Tal Leizer, Zikhron Ya'Akov (IL)

(73) Assignee: The Mushroom Benefit Ltd, Natanya (IL)

(21) Appl. No.: 16/830,315

(22) Filed: Mar. 26, 2020

(30) Foreign Application Priority Data
Mar. 28, 2019 (IL) 265714

(51) Int. Cl. A23L 27/14

(52) U.S. Cl. CPC A23L 27/14; A23V 2002/00

(57) ABSTRACT

The present invention provides dried edible mushrooms impregnated with at least one supplemental flavoring agent, products comprising them and processes for the preparation thereof.

### BACKGROUND OF THE INVENTION

Modern life exposes humans to food products that are prepared instantly from dried ingredients. Mono-solidum glutamate (MSG) is the sodium salt of the amino acid glutamic acid and a form of glutamate, used to intensify meat and spice flavorings in meats, condiments, pickles, soups, candy and baked goods. In far east cooking tradition a seaweed broth was originally used to obtain the flavor-enhancing effects of MSG, but today MSG is made by a fermenting process using starch, sugar beets, sugar cane, or molasses.

There is a trend for reducing the intake of MSG and sodium in a diet of a subject mostly for concerns of health-related reasons, such as allergies, headaches, dizziness, chest pains, and so forth

There is a growing need to replace and reduce artificial flavoring agents, salt and flavoring enhancers such as MSG, with natural flavorants for conferring flavor to foodstuff.

### SUMMARY OF THE INVENTION

The present invention provides a dried edible mushroom impregnated with at least one supplemental flavoring agent.

When referring to a “dried edible mushroom” it should be understood to encompass any type of edible mushroom having nutritional (typically contain high levels of riboflavin, niacin, and pantothenic acid with moderate content of phosphorus) and culinary value and include many fungal species that are either harvested wild or cultivated. In some embodiments, the dried mushroom of the invention is dehydrated/desiccated to reduce the level of moisture (water content) within its fibers to less than 15%. In some embodiments, the dried mushroom of the invention is dehydrated/desiccated to reduce the level of moisture within its fibers to less than 12%. In some embodiments, the dried mushroom of the invention is dehydrated/desiccated to reduce the level of moisture within its fibers to less than 10%. In some embodiments, the dried mushroom of the invention is dehydrated/desiccated to reduce the level of moisture within its fibers to less than 5%. In some embodiments, the dried mushroom of the invention is dehydrated/desiccated to reduce the level of moisture within its fibers to less than 4%. In some embodiments, the dried mushroom of the invention is dehydrated/desiccated to reduce the level of moisture within its fibers to less than 3%. In some embodiments, the dried mushroom of the invention is dehydrated/desiccated to reduce the level of moisture within its fibers to less than 2%. In some embodiments, the dried mushroom of the invention is dehydrated/desiccated to reduce the level of moisture within its fibers to less than 1%. In some embodiments, the dried mushroom of the invention is dehydrated/desiccated to reduce the level of moisture within its fibers to less than 0.5%. In some embodiments, the dried mushroom of the invention is dehydrated/desiccated to reduce the level of moisture within its fibers to less than 0.1%. In some embodiments, the dried mushroom of the invention is dehydrated/desiccated to reduce the level of moisture within its fibers to less than 0.01%. In some embodiments, the dried mushroom of the invention is dehydrated/desiccated to reduce the level of moisture within its fibers to less than 0.6 Water activity (aW).

In some embodiments, said edible dried mushroom is selected from shiitake mushroom, champignon mushroom, porcini mushroom, black trumpet mushroom, morel mushroom, matsutake mushroom, maiitake mushroom, chanterelle mushroom, turkey tail mushroom, lion's mane mushroom, Agricus blazei murrill mushroom, lobster mushroom, oyster mushroom, king oyster mushroom, truffle and any combinations thereof.

In further embodiments, said edible mushroom is sliced, kibbled, crushed, ground, shredded, chopped and any combinations thereof.

When referring to “flavoring agent” it should be understood to encompass any type of substance that gives another substance flavor. A flavor is a quality of something that affects the sense of taste. Of the three chemical senses, smell is the main determinant of a food item's flavor. The terms flavoring and flavorant denote the combined chemical sensations of taste and smell, the same terms are also used in the fragrance and flavors industry to refer to edible chemicals and extracts that alter the flavor of food and food products through the sense of smell. In the contents of the present invention, said at least one supplemental flavoring agent relates to agents other than salt, sugar, pepper or vinegar as a standalone agent or any combinations thereof. Flavorants such as salt, sugar, pepper or vinegar can each be further added to the at least one supplemental flavoring agent.

When referring to a “supplemental” flavoring agent it should be understood to encompass any type of flavoring agent that provides supplemental flavor other than the mushroom flavor.

When referring to said dried mushroom being “impregnated” with said supplemental flavoring agent it should be understood to said dried mushroom being filled, imbued, permeated, and saturated with said supplemental flavoring agent.

In some embodiments, said at least one supplemental flavoring agent is at least one herb. In some embodiments, said at least one herb is selected from oregano, basil, thyme, parsley, rosemary, sage, coriander, nigella, anise, lemongrass and any combinations thereof. In some other embodiments, said at least one herb is an Italian herb mixture (for example any combination of oregano, basil, anise, thyme, nigella, rosemary and sage in equal or different quantities). In another embodiments, said at least one herb is an oriental herb mixture (for example any combination of ginseng, ginkgo, wolfberry, Dang Gui, astragalus, atractylodes, bupleurum, Cinnamon, Coptis chinensis, ginger, licorice, ephedra, peony, Rehmannia, rhubarb, salvia, in equal or different quantities). In another embodiments, said at least one herb is a Mediterranean herb mixture (for example any combination of basil, cilantro, chives, fennel, nigella, anise, garlic, ginger, mint, onion, oregano, parsley, rosemary, sage, saffron, cinnamon, thyme, zaatar, cumin, curcumin, coriander, paprika in equal or different quantities). In another embodiments, said at least one herb is a Indian herb mixture (for example any combination of Anise, asafetida, basil, bay leaf, cumin, cardamom, caraway, carom, cinnamon, clove, coriander, fenugreek, ginger, mango powder, dried pumpkin/water melon seeds, fennel, jaggery, nigella, mace, mustard seeds, nutmeg, onion, pomegranate, poppy, saffron, sesame, tamarind, thymol, turmeric in equal or different quantities).

In some embodiments, said at least one supplemental flavoring agent further comprises at least one further mushroom flavor, such as for example truffle oil.

In some embodiments, said at least one supplemental flavoring agent is a powder dissolvable in oil. In other embodiments, said at least one supplemental flavoring agent is a powder dissolvable in water.

In some embodiments, said at least one supplemental flavoring agent is oil based.

In other embodiments, said at least one supplemental flavoring agent is water based.

In further embodiments, said at least one supplemental flavoring agent is an emulsion.

In some embodiments, said dried edible mushroom impregnated with at least one supplemental flavoring agent further comprises at least one of yeast, vegetable extract (for example tomato extract), dissolvable coating (for example edible oil spray coating), starch and any combinations thereof.

In some aspects of the invention said dried edible mushroom as defined herein above and below, is used in conferring flavor to a foodstuff In some embodiments, said flavor conferring is performed by infusion, i.e. by steeping or soaking said dried mushroom in a medium such as liquid (for example water, oil or fat) at any temperature to extract the flavouring agent into said liquid.

In some embodiments, said foodstuff is a soup, a broth, a stock, a sauce, a paste, a marinade, and any combinations thereof. In other embodiments, said foodstuff is a solid foodstuff In further embodiments, foodstuff is a liquid foodstuff

The invention further provides a product comprising at least one dried edible mushroom as defined herein above and below.

In some embodiments, said product is a sachet, bag, envelope, strainer, sac, mesh, sieve, perforated receptacle, packet, pouch and any combinations thereof, said product comprising at least one dried edible mushroom of the invention. In some embodiments, said sachet, bag, packet or pouch is made of a porous material such as for example paper, food-grade plastic, food-grade fabric (such as silk), food-grade polymer (such as for example polylactide, PLA, processed from the starch of plants such as corn, sugar cane and sugar beet) and any combinations thereof. Said sachet, bag, perforated receptacle, packet or pouch holds and contains the dried edible mushroom of the invention making it possible to infuse the flavor of the dried edible mushroom of the invention into a liquid foodstuff, for example a soup or a broth, and making it easier to dispose of the dried edible mushroom after infusion of the flavor has ended. In some embodiments, said sachet, bag, packet, perforated receptacle, or pouch have an attached piece of string with a label at the top that assists in removing it.

The invention further provides a kit comprising at least one dried edible mushroom as defined herein above and below and means for using thereof (such as for example a strainer , perforated receptacle, sieve, mesh, infuser, tea bag which may be reusable or disposable) and instructions for use.

The invention further provides a process for the manufacture of a dried edible mushroom impregnated with at least one supplemental flavoring agent, comprising the steps of: (a) providing at least one dried mushroom; (b) slicing, cutting, kibbling, crushing, grinding, shredding, chopping or any combinations thereof said at least one dried mushroom; (c) impregnating said at least one dried mushroom from step (b) with at least one supplemental flavoring agent; (d) drying said impregnated edible mushroom; thereby obtaining said dried edible mushroom impregnated with at least one supplemental flavoring agent.

In some embodiments, said impregnation step (c) is performed with a solution of at least one supplemental flavoring agent.

In some embodiments, said impregnation step (c) is performed with at least one oil-based solution of at least one supplemental flavoring agent.

In further embodiments, said impregnation step (c) is performed with at least one water-based solution of at least one supplemental flavoring agent.

In other embodiments, said impregnation step (c) is performed with at least one emulsion of at least one supplemental flavoring agent.

In other embodiments, said emulsion of at least one supplemental flavoring agent further comprises an emulsifier.

In some embodiments, said solution of impregnation step (c) further comprises at least one of yeast, vegetable extract (for example tomato extract), dissolvable coating (for example edible oil spray coating), starch and any combinations thereof.

In some embodiments, said impregnation step (c) is performed with a powder of at least one supplemental flavoring agent. In some embodiments, said process further comprises a step of powdering said mushroom of step (c) with at least one supplemental flavoring agent.

In further embodiments, said solution of at least one supplemental flavoring agent has a concentration of between about 0.05-80% wt. In further embodiments, said solution of at least one supplemental flavoring agent has a concentration of between about 20-80% wt. In further embodiments, said solution of at least one supplemental flavoring agent has a concentration of between about 10-20% wt. In further embodiments, said solution of at least one supplemental flavoring agent has a concentration of between about 5-10% wt. In further embodiments, said solution of at least one supplemental flavoring agent has a concentration of between about 0.05-5% wt. In some embodiments, said solution of at least one supplemental flavoring agent has a concentration of between about 0.05-2% wt. In some embodiments, said solution of at least one supplemental flavoring agent has a concentration of between about 2-10% wt. In some embodiments, said solution of at least one supplemental flavoring agent has a concentration of between about 5-15% wt. In some embodiments, said solution of at least one supplemental flavoring agent has a concentration of about 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 20, 25, 30, 35, 40, 45, 50, 55, 60, 65, 70, 75, 80% wt.

In some embodiments, said impregnation step (c) is performed at a temperature of between about 25° C.-75° C.

In other embodiments, said drying step (d) is performed by dehydrating said impregnated mushroom of step (c). In other embodiments, said drying step (d) is performed by desiccating said impregnated mushroom of step (c). In other embodiments, said drying step (d) is performed by freeze-drying of said impregnated mushroom of step (c). In other embodiments, said drying step (d) is performed by heating at a temperature of between about 38° C.-60° C. In other embodiments, said drying step (d) is performed by heating at a temperature of between about 38° C.-75° C. In some other embodiments, said drying step (d) is performed by at least one of dehydrating, desiccating, freeze-drying, vacuum drying, microwave drying, IR oven drying, hot air over drying, drum-drying and any combinations thereof.

In further embodiments, said drying step (d) is performed until said dried edible mushroom has less than 15% of moisture (water content). In some further embodiments, said drying step (d) is performed until said dried edible mushroom has less than 4% of moisture. In some further embodiments, said drying step (d) is performed until said dried edible mushroom has less than 3% of moisture. In some further embodiments, said drying step (d) is performed until said dried edible mushroom has less than 2% of moisture. In some further embodiments, said drying step (d) is performed until said dried edible mushroom has less than 1% of moisture. In some further embodiments, said drying step (d) is performed until said dried edible mushroom has less than 0.5% of moisture. In some further embodiments, said drying step (d) is performed until said dried edible mushroom has less than 0.1% of moisture. In some further embodiments, said drying step (d) is performed until said dried edible mushroom has less than 0.01% of moisture. In some embodiments, said drying step (d) is performed until said dried edible mushroom has less than 0.6 Water activity (aW). Water activity (aW) is the partial vapor pressure of water in a substance divided by the standard state partial vapor pressure of water. In the field of food science, the standard state is most often defined as the partial vapor pressure of pure water at the same temperature. Using this particular definition, pure distilled water has a water activity of exactly one.

The invention further provides a final edible product comprising at least one dried edible mushroom impregnated with at least one supplemental flavoring agent. Said final edible product may be a cooked product, baked product, steamed product, fried product, pressure cooked product and any combinations thereof.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Preparation of a single sachet: 1 to 5 grams of acacia gum were added to a flask. To this, 1.5 to 5 grams of oil soluble flavor concentrates were added, 1.5 to 5 grams water soluble flavor concentrates were added, 1-5 grams tomato concentrate serum were added, 1-5 grams yeast extract were added, the mixture was mixed until homogeneous powder. 35-50 ml water were added at 30-45° C. and the mixture was mixed until homogeneous solution was formed. To this mixture were added 1-10 grams of kibbled dry mushroom mix (2 to 10 mm). The resulting mixture was mixed gently for 30 -60 minutes until complete absorption of solution into the kibbled mushrooms. The absorbed mushrooms were dispersed in a uniform layer in a drying oven and dried for 35 to 120 minutes, depending on quantity of mushrooms and oven at 30-60° C. When ready, the dried product was placed into sachets with identical weights.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. Dried edible mushroom impregnated with at least one supplemental flavoring agent.

2. Dried edible mushroom according to claim 1, wherein said edible dried mushroom is selected from shiitake mushroom, champignon mushroom, porcini mushroom, black trumpet mushroom, morel mushroom, matsutake mushroom, maiitake mushroom, chanterelle mushroom, turkey tail mushroom, lion's mane mushroom, Agricus blazei murrill mushroom, lobster mushroom, truffle and any combinations thereof.

3. Dried edible mushroom according to claim 1, wherein said edible mushroom is sliced, cut, kibbled, crushed, ground, shredded, chopped or any combinations thereof.

4. Dried edible mushroom according to claim 1, wherein said at least one supplemental flavoring agent is at least one herb.

5. Dried edible mushroom according to claim 1, wherein said at least one supplemental flavoring agent is oil based.

6. Dried edible mushroom according to claim 1, wherein said at least one supplemental flavoring agent is water based. Dried edible mushroom according to claim 1, wherein said at least one supplemental flavoring agent is an emulsion.

8. Dried edible mushroom according to claim 1, for use in conferring flavor to a foodstuff.

9. A product comprising at least one dried edible mushroom according to claim 1.

10. A product according to claim 9, being selected from a sachet, a bag, a packet a perforated receptacle, a pouch, a strainer, a sieve, an envelope, a mesh and any combinations thereof.

11. A process for the manufacture of a dried edible mushroom impregnated with at least one supplemental flavoring agent, comprising the steps of: (a) providing at least one dried mushroom; (b) slicing, cutting, kibbling, crushing, grinding, shredding, chopping or any combinations thereof said at least one dried mushroom; (c) impregnating said at least one dried mushroom of step (b) with at least one supplemental flavoring agent; (d) drying said impregnated edible mushroom; thereby obtaining said dried edible mushroom impregnated with at least one supplemental flavoring agent.

12. A process according to claim 11, wherein said impregnation step (c) is performed with a solution of at least one supplemental flavoring agent.

13. A process according to claim 11, wherein said impregnation step (c) is performed with at least one oil-based solution of at least one supplemental flavoring agent.

14. A process according to claim 11, wherein said impregnation step (c) is performed with at least one water-based solution of at least one supplemental flavoring agent.

15. A process according to claim 11, wherein said impregnation step (c) is performed with at least one emulsion of at least one supplemental flavoring agent.

16. A process according to claim 11, wherein said solution of at least one supplemental flavoring agent has a concentration of between about 0.05-80% wt.

17. A process according to claim 11, wherein said impregnation step (c) is performed at a temperature of between about 25° C.-75° C.

18. A process according to claim 11, wherein said drying step (d) is performed at a temperature of between about 38° C.-75° C.

19. A process according to claim 11, wherein said drying step (d) is performed until said dried edible mushroom has less than 5% of moisture.

20. A process according to claim 11, wherein said drying step (d) is performed until said dried edible mushroom has less than 0.6 aW.
